(19) United States
(12) Patent Application Publication
(10) Pub. No.: US 2025/0174869 A1
(43) Pub. Date: May 29, 2025

(54) CONVERSION APPARATUS AND PHASED-ARRAY ANTENNA

(71) Applicants: Beijing BOE Sensor Technology Co. Ltd., Beijing (CN); BOE Technology Group Co., Ltd., Beijing (CN)

(72) Inventors: Yan LU, Beijing (CN); Yan WANG, Beijing (CN); Haocheng JIA, Beijing (CN); Di CAO, Beijing (CN); Guodong FENG, Beijing (CN); Liangrong GE, Beijing (CN); Zhifeng ZHANG, Beijing (CN)

(73) Assignees: Beijing BOE Sensor Technology Co. Ltd., Beijing (CN); BOE Technology Group Co., Ltd., Beijing (CN)

(21) Appl. No.: 19/037,477

(22) Filed: Jan. 27, 2025

Related U.S. Application Data
(63) Continuation of application No. PCT/CN2023/082390, filed on Mar. 20, 2023.

(51) Int. Cl. H01P 5/107; H01P 3/12; H01Q 13/10

(52) U.S. Cl. CPC H01P 5/107; H01P 3/121; H01Q 13/10

(57) ABSTRACT

The present disclosure relates to a conversion device. The conversion device includes a first waveguide and a transition substrate. The first waveguide includes a waveguide transmission cavity and a waveguide back cavity. The transition substrate is provided between the waveguide transmission cavity and the waveguide back cavity. The transition substrate includes at least one dielectric substrate, the dielectric substrate includes a first base substrate and at least one group of signal transmission structures, one of the signal transmission structures includes a CPW signal transmission line and a probe, the CPW signal transmission line includes a signal line and ground electrodes. The probe, the signal line and the ground electrode pass through a transition region, the probe is located in the waveguide transmission cavity, and the signal line and the ground electrode partially extend into the waveguide transmission cavity.

### CROSS-REFERENCE TO RELATED APPLICATION

The present application is a continuation of International Application No. PCT/CN2023/082390, filed on Mar. 20, 2023, the contents of which are incorporated herein by reference in its entirety.

### TECHNICAL FIELD

The present disclosure relates to the display technical field, and in particular to a conversion device and a phased-array antenna.

### BACKGROUND

A waveguide-planar transmission line conversion device is an important component in various wireless communication systems, and the performance of the conversion device directly affects the performance of the wireless communication systems.

When coupling the waveguide with a CPW transmission line, existing conversion devices are prone to high losses and mode mismatch.

It should be noted that the information disclosed in the background section is only used to enhance the understanding of the background of the present disclosure, and therefore may include information that does not constitute the prior art known to those of ordinary skill in this art.

### SUMMARY

The purpose of the present disclosure is to overcome the deficiency of the related art and to provide a conversion device and a phased-array antenna.

According to an aspect of the present disclosure, there is provided a conversion device, including: a first waveguide and a transition substrate. The first waveguide includes a waveguide transmission cavity and a waveguide back cavity, and the waveguide back cavity is provided at a side of the waveguide transmission cavity. The transition substrate provided between the waveguide transmission cavity and the waveguide back cavity. The transition substrate includes at least one dielectric substrate, the dielectric substrate includes a first base substrate and at least one group of signal transmission structures, the signal transmission structure includes a CPW signal transmission line and a probe, the CPW signal transmission line includes a signal line and a ground electrode, an input end of the signal line is connected to an output end of the probe, and the ground electrode is provided on both sides of the signal line. The first base substrate has a transition region, the CPW signal transmission line is coupled with the probe in the transition region, the probe, the signal line and the ground electrode pass through the transition region, the probe is located in the waveguide transmission cavity, and the signal line and the ground electrode partially extend into the waveguide transmission cavity.

In an embodiment of the present disclosure, the probe and the signal line are connected via a strip line, the strip line includes a plurality of interconnected strip segments, and widths of different strip segments are unequal.

In an embodiment of the present disclosure, the signal line includes a plurality of signal segments arranged along a length direction of the signal line, and impedances of different signal segments are unequal.

In an embodiment of the present disclosure, the probe includes a first probe segment and a second probe segment, a shape of the first probe segment is rectangular, and a shape of the second probe segment is a fan shape.

In an embodiment of the present disclosure, the probe includes a first probe segment, a shape of the first probe segment is rectangular, an end of the first probe segment is provided with a second notch, or both sides of the first probe segment have protrusions arranged perpendicular to a length direction of the first probe segment.

In an embodiment of the present disclosure, a first notch is provided at two adjacent ground electrodes, the first notch is located in the transition region, and two first notches are symmetrically arranged about the signal line.

In an embodiment of the present disclosure, the dielectric substrate includes at least one pair of signal transmission structures, the pair of signal transmission structures comprises two groups of signal transmission structures, and two adjacent groups of signal transmission structures are symmetrically arranged about a first direction.

In an embodiment of the present disclosure, ground electrodes located between two adjacent signal lines are connected together.

In an embodiment of the present disclosure, a length of the ground electrode in the first direction gradually decreases in a direction approaching the signal line.

In an embodiment of the present disclosure, ground electrodes between two adjacent signal lines are separated by an isolation strip.

In an embodiment of the present disclosure, the dielectric substrate includes at least two pairs of signal transmission structures, the two pairs of signal transmission structures are symmetrically arranged about a second direction, and the second direction is perpendicular to the first direction.

In an embodiment of the present disclosure, the strip line, the probe and the signal line are arranged at a side of the first base substrate close to the waveguide transmission cavity, and the ground electrode is arranged at a side of the first base substrate away from the waveguide transmission cavity.

In an embodiment of the present disclosure, the dielectric substrate further includes a second base substrate and a third base substrate, the second base substrate is sandwiched between the strip line, the probe, the signal line and the waveguide transmission cavity, and the third base substrate is sandwiched between the ground electrode and the waveguide back cavity.

In an embodiment of the present disclosure, the first waveguide is a rectangular waveguide, a circular waveguide, an elliptical waveguide, a ridge waveguide, or a ridge-gap waveguide.

In an embodiment of the present disclosure, the conversion device further includes a second waveguide, wherein the second waveguide is connected to the probe through a probe wire.

In an embodiment of the present disclosure, the conversion device includes four second waveguides, and the four second waveguides are arranged at four corners of the first waveguide and are respectively connected to a probe through a probe wire.

According to another aspect of the present disclosure, there is provided a phased-array antenna, including the conversion device according to any one of embodiment of the above aspect.

It should be understood that the foregoing general description and the following detailed description are illustrative and explanatory only, and are not intended to limit the present disclosure.

### BRIEF DESCRIPTION OF THE DRAWINGS

The accompanying drawings, which are incorporated in the specification and constitute a part of the specification, illustrate embodiments consistent with the present disclosure, and together with the specification serve to explain the principles of the present disclosure. Obviously, the accompanying drawings described below are only some embodiments of the present disclosure, and for those of ordinary skill in this art, other accompanying drawings can be obtained based on these accompanying drawings without creative work.

FIG. 1 is a schematic diagram showing a connection between a waveguide array and a probe wire according to an embodiment of the present disclosure.

FIG. 2 is a three-dimensional structural diagram of a conversion device according to an embodiment of the present disclosure.

FIG. 3 is a schematic plan view of another conversion device according to an embodiment of the present disclosure.

FIG. 4 is a simulation diagram of a signal after being transformed by a conversion device according to an embodiment of the present disclosure.

FIG. 5 is a schematic diagram of the structure of a probe according to an embodiment of the present disclosure.

FIG. 6 is a schematic diagram of the structure of another probe according to an embodiment of the present disclosure.

FIG. 7 is a schematic diagram of the structure of another probe according to an embodiment of the present disclosure.

FIG. 8 is a schematic diagram of the structure of another probe according to an embodiment of the present disclosure.

### DESCRIPTION OF REFERENCE NUMERALS

1—first waveguide, 11—waveguide transmission cavity, 12—waveguide back cavity, 2—ridge structure, 3—second waveguide, 4—dielectric substrate, 41—first base substrate, 42—signal transmission structure, 421—CPW signal transmission line, 4211—signal line, 4212—ground electrode, 4213—first notch, 4214—isolation strip, 422—probe, 4221—first probe segment, 4222—second probe segment, 4223—second notch, 4224—protrusion, 423—strip line, 4231—strip segment, 43—second base substrate, 44—third base substrate, 5—probe wire, 51—first wire segment, 511—first sub-segment, 512—second sub-segment, 52—second wire segment, 521—third sub-segment, 522—fourth sub-segment, 53—third wire segment.

### DETAILED DESCRIPTION

Example implementations will now be described more fully with reference to the accompanying drawings. However, the example implementations can be implemented in a variety of forms and should not be construed as limited to the implementations set forth herein; rather, these implementations are provided so that the present disclosure will be comprehensive and complete and fully convey the concepts of the example implementations to those skilled in the art. The same reference numerals in the figures represent the same or similar structures, and thus their detailed description will be omitted. In addition, the drawings are only schematic illustrations of the present disclosure and are not necessarily drawn to scale.

Although relative terms such as “upper” and “lower” are used in this specification to describe relative relationships between one component in a figure and another component, these terms are used only for convenience, for example, these terms are based on the directions shown in the drawings. It can be understood that if a device shown in a figure is turned upside down, a component described as “upper” will become a “lower” component. When a structure is “on” another structure, it may mean that the structure is integrally formed on another structure, or that the structure is “directly” arranged on another structure, or that the structure is “indirectly” arranged on another structure through a further structure.

The terms “one”, “a/an”, “the”, “said” and “at least one” are used to indicate the presence of one or more elements/components/etc.; the terms “include” and “have” are open terms and means inclusive, and refers to that in addition to the listed elements/components and so on, there may be other elements/components and so on. The terms “first”, “second” and “third” etc. are used only as markers and are not intended to limit the number of associated objects.

Modern wireless communication systems are rapidly developing towards miniaturization, integration and multifunctionality. In order to better integrate with low-profile planar circuits and improve the anti-interference ability of devices, it may be needed to use a waveguide-planar transmission line conversion device to couple the planar transmission line with the waveguide to solve the problem of mode conversion from the waveguide to the planar transmission line. The waveguide-planar transmission line conversion device is an important component of various wireless communication systems, and the performance of the waveguide-planar transmission line conversion device directly affects the performance of the wireless communication systems.

The conversion device usually includes a probe 422 and a CPW signal transmission line 421. The probe 422 is coupled to the CPW signal transmission line 421. By the coupling between the probe 422 and the waveguide, the signal is converted into a wire transmission mode. Then, by the coupling between the probe 422 and the CPW signal transmission line 421, the signal is converted from the wire transmission mode to the CPW transmission mode. The TE10 mode is transmitted in the waveguide, and the TEM mode is transmitted in the CPW signal transmission line 421. Therefore, there is a mode mismatch problem between the waveguide and the CPW signal transmission line 421, and the signal has conversion loss during the conversion process of different transmission modes. The more the transmission mode is converted, the greater the conversion loss will be. In addition, there is a different impedance at the connection between the probe 422 and the CPW signal transmission line 421, and the situation of impedance mismatch may easily occur.

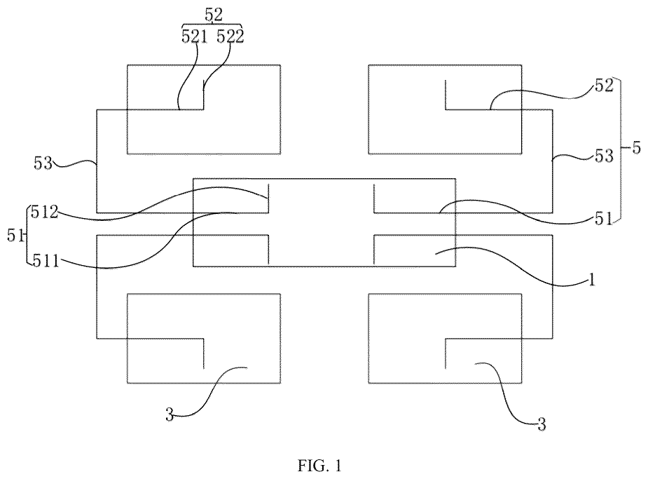

In view of the above, an embodiment of the present disclosure provides a conversion device. As shown in FIG. 1 to FIG. 8, the conversion device includes a first waveguide 1 and a transition substrate. The first waveguide 1 includes a waveguide transmission cavity 11 and a waveguide back cavity 12, and the waveguide back cavity 12 is arranged at a side of the waveguide transmission cavity 11. The transition substrate is arranged between the waveguide transmission cavity 11 and the waveguide back cavity 12, and the transition substrate includes at least one layer of dielectric substrate 4. The dielectric substrate 4 includes a first base substrate 41 and at least one group of signal transmission structures 42. A signal transmission structure 42 includes a CPW signal transmission line 421 and a probe 422. The CPW signal transmission line 421 includes a signal line 4211 and ground electrode(s) 4212. An input end of the signal line 4211 is connected to an output end of the probe 422, and the ground electrode(s) 4212 is(are) arranged on both sides of the signal line 4211. The first base substrate 41 has a transition region, the CPW signal transmission line 421 and the probe 422 are coupled in the transition region, and starting end of the ground electrode 4212, the signal line 4211 and the probe 422, pass through the transition region. The probe 422 is located in the waveguide transmission cavity 11, and the signal line 4211 and the ground electrode(s) 4212 partially extend into the waveguide transmission cavity 11.

The first base substrate 41 has a transition region, the CPW signal transmission line 421 is coupled with the probe 422 in the transition region, and starting end of the ground electrode 4212, the signal line 4211 and the probe 422 pass through the transition region. The probe 422 is located in the waveguide transmission cavity 11, and the signal line 4211 and the ground electrode(s) 4212 partially extend into the waveguide transmission cavity 11. By extending the ground electrode(s) 4212 and the signal line 4211 into the waveguide transmission cavity 11, a TEM mode can be constructed in advance in the waveguide transmission cavity 11, which can reduce the mode mismatch of the signal during the transmission procedure. A part of the signal is directly converted into the CPW transmission mode, which simplifies the mode conversion procedure of part of the signal and can reduce the conversion loss to a certain extent.

The conversion device involved in the implementation of the present disclosure is described in detail below with reference to specific embodiments.

As shown in FIG. 1, the conversion device includes a waveguide array and a probe wire 5. The waveguide array includes a first waveguide 1 and a second waveguide 3. The second waveguide 3 is connected to the first waveguide 1 through the probe wire 5. The number of the first waveguide 1 is one. In order to transmit the signal of the first waveguide 1 to the second waveguide 3, it is needed to convert the signal of the first waveguide 1 into a signal that can be transmitted by the probe wire 5. The first waveguide 1 and the second waveguide 3 may be rectangular waveguides, or the first waveguide 1 may also be set as a circular waveguide, an elliptical waveguide, a ridge waveguide or a ridge gap waveguide.

There are four second waveguides 3, which are arranged at four corners of the first waveguide 1, and are respectively connected to the first waveguide 1 through a probe wire 5. The probe wire 5 includes a first wire segment 51, a second wire segment 52 and a third wire segment 53. The first wire segment 51 is located in the first waveguide 1, the second wire segment 52 is located in the second waveguide 3, and the third wire segment 53 is connected between the first wire segment 51 and the second wire segment 52. It should be noted that the extension direction of the probe 422 is the same as the field direction in the rectangular waveguide to achieve energy coupling between the probe 422 and the rectangular waveguide.

The first wire segment 51 and the second wire segment 52 are both L-shaped. The first wire segment 51 includes a first sub-segment 511 extending along a long side direction of the first waveguide 1 and a second sub-segment 512 extending along a short side direction of the first waveguide 1. The four first sub-segments 511 enter from the short sides of both sides of the first waveguide 1 and approach each other toward the center of the first waveguide 1 along the long side extending direction of the first waveguide 1. The second sub-segment 512 is connected to an end of the first sub-segment 511 and approaches the long side of the first waveguide 1 along the short side extending direction of the first waveguide 1. The second wire segment 52 includes a third sub-segment 521 extending along a long side direction of the second waveguide 3 and a fourth sub-segment 522 extending along a short side direction of the second waveguide 3. The four third sub-segments 521 enter from the short sides of both sides of the second waveguides 3 and approach each other toward the centers of the second waveguides 3 along the long side extending direction of the second waveguides 3. The fourth sub-segment 522 approaches the long side of the second waveguide 3 along the short side extending direction of the second waveguide 3.

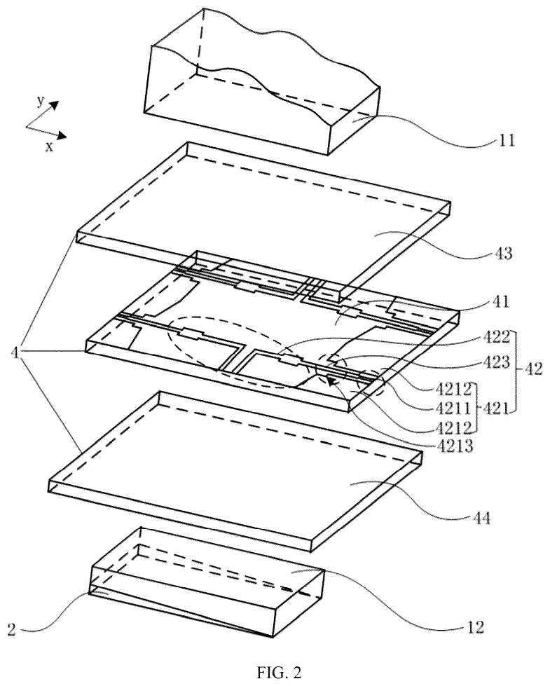

As shown in FIG. 2, the conversion device further includes a transition substrate. The signal of the first waveguide 1 is converted into a signal that can be transmitted by the probe wire 5 through the transition substrate. The first waveguide 1 includes a waveguide transmission cavity 11 and a waveguide back cavity 12. The waveguide back cavity 12 is arranged at a side of the waveguide transmission cavity 11. The transition substrate is arranged between the waveguide transmission cavity 11 and the waveguide back cavity 12. The signal is fed through the waveguide transmission cavity 11, and the waveguide back cavity 12 provides reflection, and the signal is coupled to the transition substrate through both the waveguide transmission cavity 11 and the waveguide back cavity 12. A ridge structure 2 is provided at a side of the waveguide back cavity 12 away from the waveguide transmission cavity 11.

The transition substrate includes at least one layer of dielectric substrate 4. The dielectric substrate 4 includes a first base substrate 41 and a signal transmission structure 42. The signal transmission structure 42 is arranged on a surface of the first base substrate 41. The dielectric substrate 4 includes at least one pair of signal transmission structures 42. The pair of signal transmission structures 42 includes two groups of signal transmission structures 42, and two adjacent groups of signal transmission structures 42 are symmetrically arranged about a first direction. The dielectric substrate 4 includes at least two pairs of signal transmission structures 42, and the two pairs of signal transmission structures 42 are symmetrically arranged about a second direction, and the second direction is perpendicular to the first direction. It should be noted that the first direction is the x direction shown in FIG. 2, that is, the long side direction of the first base substrate 41, and the second direction is the y direction shown in FIG. 2, that is, the short side direction of the second base substrate 43.

The signal transmission structure 42 includes a CPW signal transmission line 421 and a probe 422. The CPW signal transmission line 421 includes a signal line 4211 and ground electrode(s) 4212. An input end of the probe 422 is connected to the first wire segment 51 of the probe wire 5, and an input end of the signal line 4211 is connected to an output end of the probe 422. The ground electrode(s) 4212 is(are) arranged on both sides of the signal line 4211 along the second direction. The first sub-segment 511 of the first wire segment 51 enters from the long side of the first base substrate 41 and extends along the second direction. The second sub-segment 512 extends along the first direction and approaches the short side of the first base substrate 41, connecting the input end of the signal line 4211 with an end of the second sub-segment 512. A first notch 4213 is provided at two adjacent ground electrodes 4212, the first notch 4213 is located in the transition region, two first notches 4213 are symmetrically arranged about the signal line 4211, and the ground electrodes 4212 located between two adjacent signal lines 4211 are connected together.

In the case where the impedance of the probe 422 and the impedance of the CPW signal transmission line 421 are different, a strip line 423 is set to connect the probe 422 and the signal line 4211, and impedance matching is performed with the probe 422 and the CPW signal transmission line 421 through the strip line 423. In order to achieve a better impedance matching effect, a multi-segment line width design is performed on the strip line 423. As shown in FIG. 2, the strip line 423 includes a plurality of interconnected strip segments 4231, and the widths of different strip segments 4231 are not equal. The widths of different strip segments 4231 can be adjusted according to actual conditions. For example, as shown in this embodiment, along the second direction, the widths of different strip segments 4231 gradually decrease along a direction close to the center of the first base substrate 41. The signal line 4211 includes a plurality of signal segments arranged along its length direction, and the impedances of different signal segments are not equal.

In addition, the dielectric substrate 4 further includes a second base substrate 43 and a third base substrate 44. The second base substrate 43 is sandwiched between the strip line 423, the probe 422, the signal line 4211 and the waveguide transmission cavity 11, and the third base substrate 44 is sandwiched between the ground electrode(s) 4212 and the waveguide back cavity 12. It can be understood that the waveguide transmission cavity 11 is bonded with the second base substrate 43, the constrained electromagnetic wave is coupled to the probe 422, and the waveguide back cavity 12 is bonded with the third base substrate 44. The length of the waveguide back cavity 12 avoids a quarter of the waveguide wavelength, sacrificing the coupling efficiency of the working frequency point to achieve the creation of multiple resonant frequency points and improve the bandwidth.

The ground electrode(s) 4212 may be arranged on the same side of the first base substrate 41 as the strip line 423, the probe 422, and the signal line 4211, or may be arranged on different sides of the first base substrate 41. In this embodiment, the strip line 423, the probe 422, and the signal line 4211 are arranged on a side of the first base substrate 41 close to the waveguide transmission cavity 11, and the ground electrode(s) 4212 is(are) arranged on a side of the first base substrate 41 away from the waveguide transmission cavity 11.

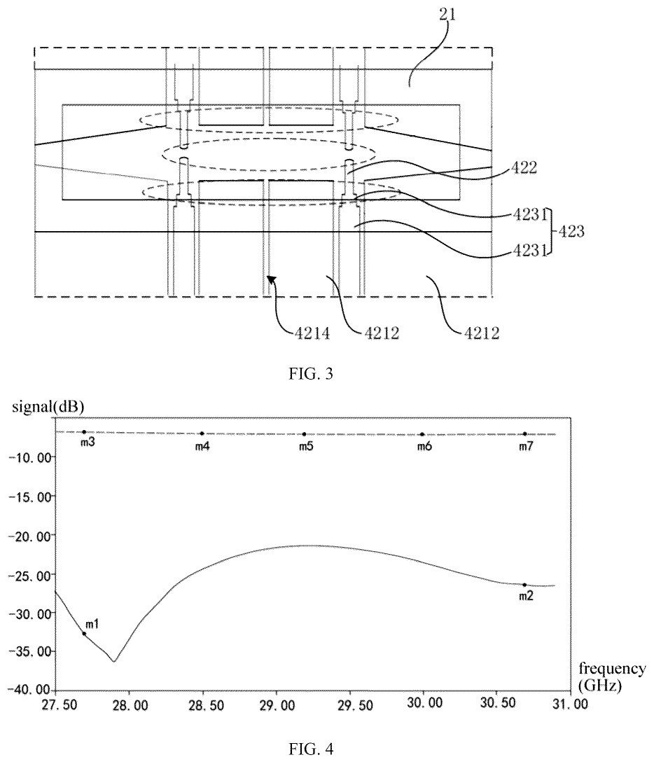

As shown in FIG. 3, in order to provide a more flexible arrangement mode for the array of the first waveguide 1 in practical applications, the probe 422 may also be located in the waveguide transmission cavity 11, and is close to the long side of the first base substrate 41 from the center of the first base substrate 41 along the second direction, and is connected to the input end of the signal line 4211. The first base substrate 41 has a transition region, and the CPW signal transmission line 421 is coupled with the probe 422 in the transition region, and then the signal of the TEM mode is output. The ground electrode(s) 4212 is(are) arranged on both sides of the signal line 4211 along the second direction, and an isolation strip 4214 is arranged between two adjacent ground electrodes 4212, and two adjacent ground electrodes 4212 are separated by the isolation strip 4214 located between the two adjacent ground electrodes 4212. Separating the two adjacent ground electrodes 4212 can guide the current and achieve matching with a larger bandwidth.

It should be noted that, regardless of FIG. 2 or FIG. 3, the CPW signal transmission line 421 is coupled with the probe 422 in the transition region, the probe 422, the signal line 4211 and the ground electrode(s) 4212 pass through the transition region, the probe 422 is located in the waveguide transmission cavity 11, and the signal line 4211 and the ground electrode(s) 4212 partially extend into the waveguide transmission cavity 11. By extending the ground electrode(s) 4212 and the signal line 4211 into the waveguide transmission cavity 11, the TEM mode can be constructed in advance in the waveguide transmission cavity 11, which can reduce the mode mismatch of the signal during the transmission procedure. A part of the signals is directly converted to the CPW transmission mode, which simplifies the mode conversion procedure of a part of the signals and can reduce the conversion loss to a certain extent.

As shown in FIG. 4, the dotted line is the loss line, and the solid line is the return loss line. Seven points are arbitrarily selected from FIG. 4, of which five points m3 (27.7000, −6.8686), m4 (28.5000, −6.9589), m5 (29.2000, −7.0762), m6 (30.0000, −7.1170), and m7 (30.7000, −7.1117) are located on the loss line, and two points m1 (27.7000, −32.8962) and m2 (30.7000, −26.4967) are located on the return loss line. The abscissa of m1 is the same as that of m3, and the abscissa of m2 is the same as that of m7. The above data shows that the conversion device can match a larger bandwidth and has a lower loss when signal changes.

In the procedure of matching from the probe 422 to the CPW signal line 4211, there is still a risk of mode mismatch and impedance mismatch at the transition position from the wire transmission mode to the strip line 423 transmission mode and at the transition position from the strip line 423 transmission mode to the CPW transmission mode. Thus, deformed ground electrode(s) 4212 and a deformed transmission line are further designed. Specifically, the length of the ground electrode 4212 on at least one side of the signal line 4211 in the first direction gradually decreases along the direction close to the signal line 4211. The signal line 4211 includes a plurality of signal segments arranged along its length direction, and the impedances of different signal segments are not equal.

As shown in FIG. 2, the lengths of the ground electrodes 4212 on both sides of the signal line 4211 in the first direction gradually decrease in the direction close to the signal line 4211. Because the ground electrodes 4212 between the two signal lines 4211 are connected together, the lengths of the ground electrodes 4212 in the first direction are the longest in the middle of the short side of the first base substrate 41, and gradually shorten in the second direction toward the signal lines 4211 on both sides. As shown in FIG. 3, the length of the ground electrode 4212 located only on outside of the signal line 4211 in the first direction gradually decreases in the direction close to the signal line 4211, while the length of the ground electrode 4212 located between the two signal lines 4211 remains unchanged in the second direction.

The input impedance of the probe 422 is a function of the width and the length of the probe 422, the height of the waveguide back cavity 12 and the frequency. There is a combination of the length and the width of the probe 422 and the height of the waveguide back cavity 12, so that the input impedance changes very little with the frequency, that is, the real part and the imaginary part of the impedance are basically not affected by the frequency. This embodiment selects a combination of the length and the width of the probe 422 and the height of the back cavity that changes very little with the frequency, and the capacitance and inductance of the probe 422 can be adjusted by changing the current path of the probe 422 and increasing the resonant frequency point(s), and thus this embodiment can increase the bandwidth of the signal that can be matched to a certain extent.

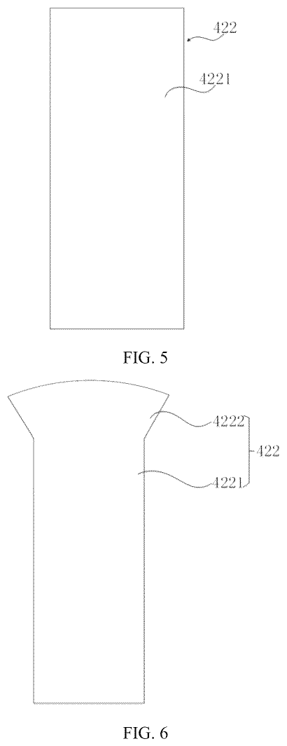

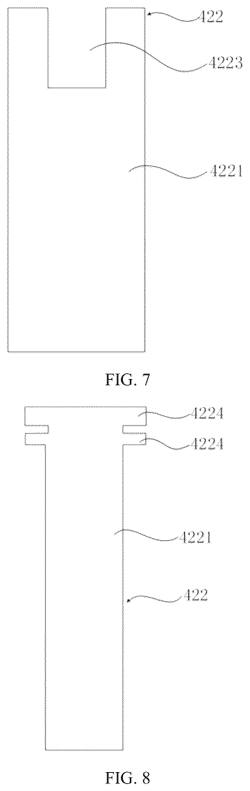

As shown in FIG. 5, the probe 422 generally includes a first probe segment 4221, and the shape of the first probe segment 4221 is a rectangle, that is, the shape of the probe 422 is generally a single rectangle. As shown in FIG. 6, in order to increase the bandwidth of the signal that can be matched, the probe 422 may also include a second probe segment 4222, and the shape of the second probe segment 4222 is a fan shape. The probe 422 may also be set to other shapes. As shown in FIG. 7, the probe 422 includes a first probe segment 4221, and a second notch 4223 is set at an end of the first probe segment 4221. As shown in FIG. 8, two pairs of protrusions 4224 may also be set on both sides of the first probe segment 4221 along a direction perpendicular to a length direction of the first probe segment 4221. Of course, more pairs of protrusions 4224 may also be set on the first probe segment 4221. This is only an example description and is not specifically limited. Each pair of protrusions 4224 includes two protrusions 4224, and the two protrusions 4224 are symmetrically arranged with respect to the first probe segment 4221. The widths of different pairs of protrusions 4224 may be the same or different.

An embodiment of the present disclosure also provides a phased-array antenna. The phased-array antenna may include the conversion device provided above. Regarding the specific structure and beneficial effects of the phased-array antenna, reference can be made to the beneficial effects of the conversion device, which will not be described in detail here.

Those skilled in the art will readily appreciate other embodiments of the present disclosure after considering the specification and practicing the disclosed content herein. The present disclosure is intended to cover any modification, use or adaptation of the present disclosure, which follows the general principles of the present disclosure and includes common knowledge or customary means in the art that are not disclosed in the present disclosure. The specification and embodiments are intended to be illustrative only, and the true scope and spirit of the present disclosure are indicated by the appended claims.

What is claimed is:

1. A conversion device, comprising:
a first waveguide comprising a waveguide transmission cavity and a waveguide back cavity, wherein the waveguide back cavity is provided at a side of the waveguide transmission cavity;
a transition substrate provided between the waveguide transmission cavity and the waveguide back cavity, wherein the transition substrate comprises at least one dielectric substrate, the dielectric substrate comprises a first base substrate and at least one group of signal transmission structures, one of the signal transmission structures comprises a Coplanar Waveguide (CPW) signal transmission line and a probe, the CPW signal transmission line comprises a signal line and ground electrodes, an input end of the signal line is connected to an output end of the probe, and the ground electrodes are provided on both sides of the signal line;
wherein the first base substrate has a transition region, the CPW signal transmission line is coupled with the probe in the transition region, the probe, the signal line and the ground electrode pass through the transition region, the probe is located in the waveguide transmission cavity, and the signal line and the ground electrode partially extend into the waveguide transmission cavity.

2. The conversion device according to claim 1, wherein the probe and the signal line are connected via a strip line, the strip line comprises a plurality of interconnected strip segments, and widths of different strip segments are unequal.

3. The conversion device according to claim 1, wherein the signal line comprises a plurality of signal segments arranged along a length direction of the signal line, and impedances of different signal segments are unequal.

4. The conversion device according to claim 1, wherein the probe comprises a first probe segment and a second probe segment, a shape of the first probe segment is rectangular, and a shape of the second probe segment is a fan shape.

5. The conversion device according to claim 1, wherein the probe comprises a first probe segment, a shape of the first probe segment is rectangular, an end of the first probe segment is provided with a second notch, or both sides of the first probe segment have protrusions arranged perpendicular to a length direction of the first probe segment.

6. The conversion device according to claim 1, wherein a first notch is provided at two adjacent ground electrodes, the first notch is located in the transition region, and two first notches are symmetrically arranged about the signal line.

7. The conversion device according to claim 1, wherein the dielectric substrate comprises at least one pair of signal transmission structures, the pair of signal transmission structures comprises two groups of signal transmission structures, and two adjacent groups of signal transmission structures are symmetrically arranged about a first direction.

8. The conversion device according to claim 7, wherein ground electrodes located between two adjacent signal lines are connected together.

9. The conversion device according to claim 8, wherein a length of one of the ground electrodes in the first direction gradually decreases in a direction approaching the signal line.

10. The conversion device according to claim 7, wherein ground electrodes between two adjacent signal lines are separated by an isolation strip.

11. The conversion device according to claim 7, wherein the dielectric substrate comprises at least two pairs of signal transmission structures, the two pairs of signal transmission structures are symmetrically arranged about a second direction, and the second direction is perpendicular to the first direction.

12. The conversion device according to claim 2, wherein the strip line, the probe and the signal line are arranged at a side of the first base substrate close to the waveguide transmission cavity, and the ground electrode is arranged at a side of the first base substrate away from the waveguide transmission cavity.

13. The conversion device according to claim 12, wherein the dielectric substrate further comprises a second base substrate and a third base substrate, the second base substrate is sandwiched between the strip line, the probe, the signal line and the waveguide transmission cavity, and the third base substrate is sandwiched between the ground electrode and the waveguide back cavity.

14. The conversion device according to claim 1, wherein the first waveguide is a rectangular waveguide, a circular waveguide, an elliptical waveguide, a ridge waveguide, or a ridge-gap waveguide.

15. The conversion device according to claim 1, further comprising at least one second waveguide, wherein one of the at least one second waveguide is connected to the probe through a probe wire.

16. The conversion device according to claim 15, wherein the at least one second waveguide, comprises four second waveguides, and the four second waveguides are arranged at four corners of the first waveguide and are respectively connected to a corresponding probe through a probe wire.

17. A phased-array antenna, comprising a conversion device;
wherein the conversion device comprises:
a first waveguide comprising a waveguide transmission cavity and a waveguide back cavity, wherein the waveguide back cavity is provided at a side of the waveguide transmission cavity;
a transition substrate provided between the waveguide transmission cavity and the waveguide back cavity, wherein the transition substrate comprises at least one dielectric substrate, the dielectric substrate comprises a first base substrate and at least one group of signal transmission structures, one of the signal transmission structures comprises a Coplanar Waveguide (CPW) signal transmission line and a probe, the CPW signal transmission line comprises a signal line and ground electrodes, an input end of the signal line is connected to an output end of the probe, and the ground electrodes are provided on both sides of the signal line;
wherein the first base substrate has a transition region, the CPW signal transmission line is coupled with the probe in the transition region, the probe, the signal line and the ground electrode pass through the transition region, the probe is located in the waveguide transmission cavity, and the signal line and the ground electrode partially extend into the waveguide transmission cavity.

18. The phased-array antenna according to claim 17, wherein the probe and the signal line are connected via a strip line, the strip line comprises a plurality of interconnected strip segments, and widths of different strip segments are unequal.

19. The phased-array antenna according to claim 17, wherein the signal line comprises a plurality of signal segments arranged along a length direction of the signal line, and impedances of different signal segments are unequal.

20. The phased-array antenna according to claim 17, wherein the probe comprises a first probe segment and a second probe segment, a shape of the first probe segment is rectangular, and a shape of the second probe segment is a fan shape.
